(19) United States
(12) Patent Application Publication
(10) Pub. No.: US 2004/0259965 A1
(43) Pub. Date: Dec. 23, 2004

(54) Electroconductive silicone rubber sponge

(76) Inventors: Kazuo Higuchi, Chiba Prefecture (JP); Hiroshi Honma, Chiba Prefecture (JP); Katsuya Baba, Chiba Prefecture (JP); Akito Nakamura, Chiba Prefecture (JP)

Correspondence Address: Robert L McKellar, Poseyville Professional Complex, 784 South Poseyville Road, Midland, MI, 48640, US

(21) Appl. No.: 10/489,484

(22) PCT Filed: Sep. 18, 2002
(86) PCT No.: PCT/JP02/09590

(30) Foreign Application Priority Data
Sep. 21, 2001 (JP) 2001-288455

(51) Int. Cl. C08J 9/00; C08K 3/00

(52) U.S. Cl. 521/82; 521/91

(57) ABSTRACT

An electroconductive silicone rubber sponge composition comprising: 100 parts by weight of a polyorganosiloxane, 1 to 100 parts by weight of all electroconductive filler such as carbon black, 0.01 to 50 parts by weight of a hollow thermoplastic resin powder, 0.1 to 10 parts by weight of a liquid compound that has a boiling point above room temperature, preferably water or an alcohol and a curing agent in an amount sufficient to cure the composition. An optional reinforcing filler may be added. The composition is capable of forming an electroconductive silicone rubber sponge having uniform and microfine foam cells. Methods for preparing the composition and the sponge are also disclosed

This invention relates to an electroconductive silicone rubber sponge composition, a method for the preparation of the composition, an electroconductive silicone rubber sponge and a method for the preparation of the sponge. More particularly, this invention relates to a composition that can form an electroconductive silicone rubber sponge having uniform and microfine foam cells and to a method for preparing said composition.

Electroconductive silicone rubber sponges, having a resistivity of from 10⁹ to 10 Ω·cm, may be obtained by the incorporation of a foaming agent and a sufficient amount of an electrically conductive material (e.g., carbon black) in to a silicone rubber composition and heat curing the resulting composition. The resulting electroconductive silicone rubber sponges are typically light-weight and exhibit excellent resistance to heat and ageing. They are used in a broad range of applications such as for automotive parts and components for office equipment. Specific applications include various types of sealing materials, packings, gaskets, O-rings, and roll coverings.

These electroconductive silicone rubber sponges are typically prepared utilizing a thermally decomposable organic foaming agent such as an azobisisobutyronitrile (see for example U.S. Pat. No. 5,482,978). Rubber sponges resulting from such processes tend to suffer from a number of problems, including the fact that the properties of the sponge are impaired by decomposition residues from the organic foaming agent and decomposition gases may be toxic and can have an unpleasant odour. Furthermore, such organic foaming agents are known to inhibit the curing of a platinum cured silicone rubber sponge.

Examples of silicone rubber sponge compositions that do not use organic foaming agent include:

Japanese Patent Application Publication (Kokai) Number Hei 08-12888 which describes a silicone rubber sponge composition containing thermally expandable microcapsules that expand at temperatures of from 80 to 200° C., and Japanese Patent Application Publication (Kokai) Numbers 2000-186210 (equivalent to U.S. Pat. No. 6,274,648) and 2000-309710 which provide silicone rubber compositions that contain hollow fillers having an average particle size no greater than 200 μm. However, in order to secure an acceptably foamed sponge the hollow fillers in these silicone rubber compositions must be admixed in large amounts to meet the required degree of foaming, resulting in problems such as increased costs, difficulty in blending the hollow filler, and a loss of properties, such as the heat resistance of the silicone rubber sponge, due to the influence of the wall material of the admixed hollow filler. Japanese Patent Application Publication (Kokai) Number Hei 6-207038 (equivalent to U.S. Pat. No. 5,332,762) provides a method for obtaining silicone rubber sponge in which water, in the form of a water-based emulsion, is used as the foaming agent. The foam cells in the silicone rubber sponge afforded by this method, however, do not exhibit an acceptable uniformity or microfineness, and it has been quite difficult using this silicone rubber sponge to satisfy the properties required for a roll covering material.

US 2001/0016609 A1 describes a silicone rubber composition comprising a heat curable organopolysiloxane composition containing expanded or unexpanded organic resin-based microspheres and a polyhydric alcohol or derivative thereof which is said to be for use as a low specific gravity silicone rubber elastomer.

The present invention was achieved by its inventors as a result of extensive investigations directed to solving the problems identified above. An object of this invention is to provide a composition for the formation of an electroconductive silicone rubber sponge, which forms an electroconductive silicone rubber sponge that exhibits uniform and microfine foam cells. Another object of this invention is to provide an electroconductive silicone rubber sponge that exhibits uniform and microfine foam cells.

In accordance with the present invention there is provided an electroconductive silicone rubber sponge composition comprising:

(A) 100 parts by weight of a polyorganosiloxane having a weight average degree of polymerisation of at least 1000,

(B) 1 to 100 parts by weight of an electroconductive filler,

(C) 0.01 to 50 parts by weight of a hollow thermoplastic resin powder,

(D) 0.1 to 10 parts by weight of a liquid compound that has a boiling point above room temperature, and

a curing agent in an amount sufficient to cure the composition.

The polyorganosiloxane (A) is the main component of the composition in accordance with the present invention. Component (A) is a polyorganosiloxane which preferably has an average unit formula RₐSiO_{(4-a)/2} and which may have a linear or partially branched structure but is preferably linear. Each R may be the same or different and is a substituted or non-substituted monovalent hydrocarbon group which may, for example, be alkyl groups such as methyl, ethyl, propyl, isopropyl, butyl, and octyl groups; aryl groups such as phenyl and tolyl groups; alkenyl groups such as vinyl, allyl, butenyl, hexenyl, and heptenyl groups; and halogenated alkyl groups such as chloropropyl and 3,3,3-trifluoropropyl groups. Preferably the hydrocarbon group is an alkyl group, most preferably methyl group. Hydroxyl groups may additionally be present, for example, in molecular chain terminal positions.

Preferred alkenyl groups are hexenyl and most preferably vinyl groups. The or each alkenyl group may be either a terminal group or may be pendant on the molecular chain.

The following are examples of preferred component (A):

dimethylvinylsiloxy-endblocked polydimethylsiloxane,

trimethylsiloxy-endblocked polydimethylsiloxane,

trimethylsiloxy-endblocked dimethylsiloxane-methylvinylsiloxane copolymer,

dimethylvinylsiloxy-endblocked dimethylsiloxane-methylvinylsiloxane copolymer,

dimethylhydroxysiloxy-endblocked polydimethylsiloxane,

dimethylhydroxysiloxy-endblocked dimethylsiloxane-methylvinylsiloxane copolymer,

methylvinylhydroxysiloxy-endblocked dimethylsiloxane-methylvinylsiloxane copolymer,

dimethylhexenylsiloxy-endblocked polydimethylsiloxane,

trimethylsiloxy-endblocked dimethylsiloxane-methylhexenylsiloxane copolymer,

dimethylhexenylsiloxy-endblocked dimethylsiloxane-methylhexenylsiloxane copolymer,

dimethylvinylsiloxy-endblocked dimethylsiloxane-methylphenylsiloxane copolymer,

dimethylhexenylsiloxy-endblocked dimethylsiloxane-methylphenylsiloxane copolymer,

dimethylvinylsiloxy-endblocked dimethylsiloxane-methyl(3,3,3-trifluoropropyl)siloxane copolymer,

dimethylhexenylsiloxy-endblocked dimethylsiloxane-methyl(3,3,3-trifluoropropyl)siloxane copolymer, and

mixtures of two or more of these polyorganosiloxanes.

The weight-average degree of polymerization of component (A) is at least 1000 and is preferably in a range of from 1,000to20,000. More preferably the weight-average degree of polymerization of component (A) is from 2500 to 20 000. It is to be understood that the term weight-average degree of polymerisation means that said degree of polymerisation was determined on the basis of the weight average molecular weight (Mw) of the polymer. Preferably all of the examples of component (A) above are gums i.e. polymers as defined above with a weight-average degree of polymerization of at least about 3000.

Component (B), the electroconductive filler, maybe any one or more suitable filler(s) which can impart the required electroconductivity to the composition of the present invention. Component (B) may, for example, be one or more carbon conductors such as carbon black, carbon fibre, and graphite; metal powders such as gold, silver, and/or nickel powders; electroconductive zinc oxide, electroconductive titanium oxide, and electroconductive aluminium oxide. Alternatively the electroconductive fillers of component (B) may be electroconductive fillers which have been pre-treated with an electroconductive coating or covering on the surface thereof, by means of, for example, metal plating the surface of various fillers. The above electroconductive fillers maybe used individually or in mixtures providing such mixtures do not impair the object of the present invention. The electroconductive filler is added in a range of from 1 to 100parts by weight per 100 parts by weight of component (A) and preferably from 5 to 70 parts by weight per 100 parts by weight of component (A). Electroconductivity will not be obtained, in some cases, below the lower limit of the given range, purely because of the lack of a sufficient amount of electroconductive filler, while a good-quality sponge will not be obtained, in some cases, at values above the upper limit on the given range because the plasticity of the composition becomes too high resulting in an inadequate volume expansion ratio.

Carbon black is particularly preferred for component (B) because it provides good conductivities at small levels of addition thereof. Whilst carbon blacks typically used in ordinary electroconductive rubber compositions may be used for component (B), carbon blacks with a pH of from 6 to 10, prepared from low-sulphur starting materials are particularly preferred in order to avoid cure inhibition of the composition in accordance with the present invention. Preferred carbon blacks include, for example, acetylene blacks, conductive furnace blacks (CF), superconductive furnace blacks (SCF), extraconductive furnace blacks (XCF), conductive channel blacks (CC), and high-temperature heat-treated furnace blacks and channel blacks which are typically heat-treated at temperatures in the region of 1500° C. or above. Preferred acetylene blacks include, for example, Denka Black from Denki Kagaku Kogyo Kabushiki Kaisha and Shawnigan Acetylene Black from Shawnigan Chemical. Preferred conductive furnace blacks may include, for example, Continex CF from Continental Carbon Co. and Vulcan C from the Cabot Corporation. Preferred superconductive furnace blacks may include for example, Continex SCF from Continental Carbon Co. and Vulcan SC from the Cabot Corporation. Preferred extraconductive furnace blacks may include, for example, Asahi HS-500 from Asahi Carbon Kabushiki Kaisha and Vulcan XC-72 from the Cabot Corporation. Preferred conductive channel blacks may include, for example, Corax L from Degussa AG. Further alternatives for component (B) include Ketjenblack EC and Ketjenblack EC-600JD, which are both furnace blacks, from the Ketjen Black International Company.

The acetylene blacks are particularly well suited for use in the present invention as a consequence of their low impurity contents and their excellent electroconductivities originating from the fact that they have a developed secondary structure. Also preferred for use are Ketjenblack EC and Ketjenblack EC-600JD, which due to their superior specific surface areas exhibit excellent electroconductivities even at low fill levels.

When the electroconductive silicone rubber sponge is required to exhibit a relatively high electrical resistance, it is preferred that rather than using the aforementioned carbon blacks, a carbon black having a dibutyl phthalate (DBP) oil absorption of 100 or less is used, either by itself or in combination with a carbon black as described above. This latter type of carbon black may be exemplified by RCF #5 and RCF #10 from Mitsubishi Kagaku Kabushiki Kaisha; Asahi #50 and Asahi Thermal from Asahi Carbon Kabushiki Kaisha; and Monarch 120, Black Pearls 120, and Black Pearls 130 from the Cabot Corporation.

The hollow thermoplastic resin powder (C) used in this invention has a dual role, it forms a nuclei for the foam cells formed in the electroconductive silicone rubber sponge resulting from the thermal cure of the composition in accordance with the present invention, and, simultaneously functions to homogenize the size of the foam cells. Component (C) is a hollow powder, each particle of which comprises a thermoplastic resin shell and a hollow interior which contains a gas. Preferred thermoplastic resins may include, for example, silicone resins, acrylic resins, or polycarbonate resins. The thermoplastic resin preferably has a softening point of from 40 to 200° C. and more preferably from 60 to 180° C. The gas enclosed in this hollow powder may be any suitable gas but is preferably air or an inert gas such as nitrogen or helium. Component (C) preferably has an average particle size ranging from 0.1 to 500 μm, and more preferably from 1 to 50 μm.

Component (C) may be produced, for example, by preparing a dispersion of water and thermoplastic resin dissolved in a suitable solvent (typically organic based) and spraying this dispersion from a nozzle into a hot gas current in order to particulate the thermoplastic resin while the solvent is driven off. Component (C) is added in a range of from 0.01 to 50 parts by weight per 100 parts by weight of component (A) and preferably in a range of from 0.1 to 40 parts by weight per 100 parts by weight of component (A).

Component (D) is a liquid compound whose boiling point is higher than room temperature. Component (D) functions as a foaming agent by volatilizing during the formation of electroconductive silicone rubber sponge by the thermal cure of the composition in accordance with the present invention, and this component, together with component (C), is essential for inducing the formation of uniform and microfine foam cells. If this liquid were to have a boiling point lower than room temperature, it would undergo volatilization during storage of the composition in accordance with the present invention, which could prevent the production of a good-quality electroconductive silicone rubber sponge. Any suitable liquid with a boiling point higher than room temperature may be utilised and is selected based on the method for preparing the electroconductive silicone rubber sponge used and the associated preparative conditions. However, component (D) is preferably a liquid with a boiling point ranging from 25 to 200° C. and more preferably ranging from 50 to 180° C.

It is important that Component (D) must not:

dissolve the shell material of component (C) during storage of the composition in accordance with the present invention,

be degraded by heat during the formation of electroconductive silicone rubber sponge by thermal cure of the composition in accordance with the present invention, and

chemically react with other components used in the composition.

Component (D) may be exemplified by one or more of the following water;

alcohols such as methanol, ethanol, 1-propanol, and cyclohexanol;

ethylene glycol derivatives such as ethylene glycol monoethyl ether and ethylene glycol monoethyl ether acetate;

cyclic dimethylsiloxane oligomers such as hexamethylcyclotrisiloxane and octamethylcyclotetrasiloxane;

trimethylsiloxy-endblocked dimethylsiloxane oligomers;

dimethylhydroxysiloxy-endblocked dimethylsiloxane oligomers; and mixtures of any two or more thereof.

Cyclic dimethylsiloxane oligomers and particularly water are most preferred for use as component (D). When component (D) is water, it may be any suitable form of high purity water such as, for example, distilled water, ultra filtrated and ion-exchanged water, ion-exchange water and the like.

When component (D) is water, providing the functionality of the composition in accordance with the present invention is not impaired, said water may be introduced into the composition in the form of a mixture with a water-soluble silicone or in the form of a water-in-oil emulsion in which the oil layer is a silicone oil. The water-soluble silicone is a silicone capable of dissolution in water, but its type and other features are not otherwise critical. The amount of water-soluble silicone introduced into the water is not critical, but is preferably from 1 to 80 weight % and more preferably from 5 to 70 weight % and may be selected from one or more of polyoxyalkylene-modified silicone oils, aminoalkyl-functional silicone oils, amide-functional silicone oils, and carbinol-functional siloxane oligomers, of which the polyoxyalkylene-modified silicone oils are most preferred. The polyoxyalkylene-modified silicone oils may be exemplified by organopolysiloxanes bearing polyoxyalkylene groups in terminal and/or pendant positions.

The following are an example of possible average molecular formulae of water-soluble silicones which may be utilised in the present invention:

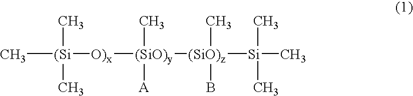

wherein

x and y are both integers, z is 0 or an integer; and

A is an organic group with the general formula:

—(CH₂)_{b}—O—(C₂H₄O)ₚ(C₃H₆O)_{q}R¹

wherein

b is an integer from 1 to 3, p is an integer, q is 0 or an integer,

R¹ is hydrogen atom or a C₁ to C₄ alkyl group such as methyl, ethyl, propyl and isopropyl; and B is an organic group with the general formula —(CH₂)ₙ—CH₃ (n is an integer from 7 to 23);

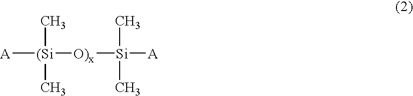

wherein both x and A are defined as above; and

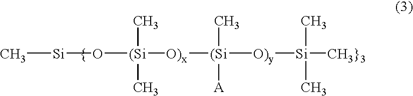

wherein each of x, y, and A are defined as above.

In order to obtain good water solubility for the polyoxyalkylene-modified silicone oil, the polyoxyalkylene moiety is preferably a polyoxyethylene or an oxyethylene-oxypropylene copolymer and its content in the molecule is preferably at least 50 weight %.

The aforementioned water-in-oil emulsion may be easily prepared by dispersing water in a silicone oil using a surfactant. The water content in this water-in-oil emulsion is not critical, but is preferably from 1 to 80 weight % and more preferably from 20 to 70 weight %. The silicone oil constituting the oil layer is an oligomer or polymer whose main skeleton is composed of diorganosiloxane units, but its type and other features are not otherwise critical providing it is a liquid. A typical example of this silicone oil is a diorganopolysiloxane having the general formula illustrated below:

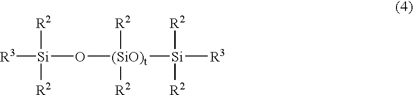

Wherein each R² is the same or different and is a monovalent hydrocarbon or halogenated alkyl group, and each R³ is the same or different and is either an hydroxyl group or an R² group. The monovalent hydrocarbon group may be exemplified by alkyl groups such as methyl, ethyl, isopropyl, propyl, butyl, pentyl, and hexyl; alkenyl groups such as vinyl, allyl, and hexenyl; cycloalkyl groups such as cyclohexyl; aralkyl groups such as β-phenylethyl; and aryl groups such as phenyl. The halogenated alkyl group may be exemplified by 3-chloropropyl and 3,3,3-trichloropropyl. Preferably each R² is an alkyl group, most preferably a methyl group and t is 0 or an integer. This diorganopolysiloxane preferably has a viscosity at 25° C. of from 1 to 100,000 mPa.s and more preferably from 10 to 100,000 mPa.s.

The surfactant required for such a water-in-oil emulsion should be capable of generating the water-in-oil emulsion and should not cause cure inhibition, but its type and so forth are not otherwise critical. The surfactant may be exemplified by diorganopolysiloxanes having pendant polyoxyalkylene chains, as illustrated by the following general formula:

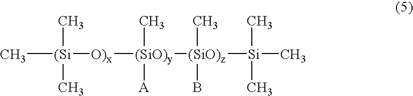

(wherein x, y, z, A, and B are defined above as above); polydimethylsiloxanes having terminal A groups which are defined in the above formula; nonionic surfactants such as polyoxyethylene sorbitan fatty acid esters, polyoxyethylene sorbitol fatty acid esters, polyethylene glycol fatty acid esters, polyoxyethylene alkyl ethers, and polyoxyethylene alkylphenyl ethers; and mixtures thereof with said polyoxyalkylene-functional organopolysiloxanes.

Component (D) is added in a range of from 0.01 to 10 parts by weight per 100 parts by weight of component (A). Additions in excess of 10 parts by weight lead to a coarsening of cells in the moulded sponge and thereby facilitate non-uniformity. An addition below 0.01 parts by weight prevents this component from satisfactorily fulfilling its role as a foaming agent.

The curing agent (E) causes the cure of the composition in accordance with the present invention. Any suitable curing agent may be utilised. Organoperoxides are an example of typical curing agents which may be used in accordance with the present invention. Organoperoxides which may be used include benzoyl peroxide, di-tert-butyl peroxide, 2,5-dimethyl-2,5-di(tert-butylperoxy)hexane, monomethylbenzoylperoxides (e.g., bis(ortho-methylbenzoyl)peroxide, bis(meta-methylbenzoyl)peroxide, bis(para-methylbenzoyl)peroxide), dimethylbenzoylperoxides such as bis(2,4-dimethylbenzoyl)peroxide, and bis(2,4,6-trimethylbenzoyl)peroxide. Organoperoxide curing agents should be added in a range of from 0.1 to 10 parts by weight per 100 parts by weight of the mixture of components (A), (B), (C) and (D).

In the case when each molecule of Component (A) contains at least two alkenyl groups, such as vinyl groups, die curing of the composition in accordance with the present invention may be carried out using an addition curing reaction, in which case component (E) preferably comprises a platinum-based catalyst suitable for use in combination with a polyorganosiloxane having at least two silicon-bonded hydrogen atoms per molecule, which combination is the preferred curing agent for the composition in accordance with the present invention because it enables the curing characteristics to be freely varied.

The polyorganosiloxane having at least two silicon-bonded hydrogen atoms per molecule may be, for example, one or more of the following:

trimethylsiloxy-endblocked polymethylhydrogensiloxanes;

trimethylsiloxy-endblocked dimethylsiloxane-methylhydrogensiloxane copolymers;

dimethylhydrogensiloxy-endblocked dimethylsiloxane-methylhydrogensiloxane copolymers;

cyclic dimethylsiloxane-methylhydrogensiloxane copolymers;

cyclic polymethylhydrogensiloxanes;

organopolysiloxanes that contain (CH₃)₃SiO_{1/2}, (CH₃)₂HSiO_{1/2}, and SiO_{4/2} siloxane units;

organopolysiloxanes that contain (CH₃)₂HSiO_{1/2} and CH₃SiO_{3/2} siloxane units;

organopolysiloxanes that contain (CH₃)₂HSiO_{1/2}, (CH₃)₂SiO_{2/2}, and CH₃SiO_{3/2} siloxane unit

dimethylhydrogensiloxy-endblocked polydimethylsiloxanes;

dimethylhydrogensiloxy-endblocked dimethylsiloxane-methylphenylsiloxane copolymers;

dimethylhydrogensiloxy-endblocked dimethylsiloxane-methyl(3,3,3-trifluoropropyl)siloxane copolymers; and

mixtures of two or more of the preceding polyorganosiloxanes.

The viscosity of the polyorganosiloxane having at least two silicon-bonded hydrogen atoms per molecule at 25° C. is not critical, but a range of from 2 to 100,000 mPa.s is preferred. The polyorganosiloxane having at least two silicon-bonded hydrogen atoms per molecule must be added in a quantity such that the ratio between the total number of moles of Si-bonded hydrogen in this polyorganosiloxane and the total number of moles of alkenyl in component (A) is between from 0.5:1 to 20:1.

The platinum-based catalyst for component (E) is exemplified by microparticulate platinum, chloroplatinic acid, alcohol-modified chloroplatinic acid, chelates of platinum, diketone complexes of platinum, coordination compounds between an olefin and chloroplatinic acid, alkenylsiloxane complexes of chloroplatinic acid, and the preceding supported on carriers such as alumina, silica, or carbon black. Chloroplatinic acid/alkenylsiloxane complexes are preferred in view of their high activity as addition cure (hydrosilylation) catalysts, but most preferred are the platinum/alkenylsiloxane complexes as disclosed in Japanese Patent Publication (Kokoku) Number Sho 42-22924 (equivalent to U.S. Pat. No. 3,419,593). Alternatively spherical microparticulate catalysts comprising a thermoplastic resin containing a platinum-based catalyst at a level of at least 0.01 weight % of platinum metal atoms may be utilised. The amount of platinum metal from the platinum catalyst is preferably from 0.01 to 500 parts by weight per 1,000,000 parts by weight (A) and is more preferably from 0.1 to 100 parts by weight per 1,000,000 parts by weight (A).

Preferably a cure inhibitor is included in the composition in accordance with the present invention when component (E) comprises the combination of a platinum-based catalyst and a polyorganosiloxane containing at least two silicon-bonded hydrogen atoms in each molecule. The cure inhibitor is preferably added to improve handling characteristics and storage stability of the composition in accordance with the present invention. This cure inhibitor may be selected from, for example, any one or more of the following:

acetylenic compounds such as 2-methyl-3-butyn-2-ol, 2-phenyl-3-butyn-2-ol, 3,5-dimethyl-1-hexyn-3-ol, 1-ethynyl-1-cyclohexanol, 1,5-hexadiyne, and 1,6-heptadiyne;

en-yne compounds such as 3,5-dimethyl-1-hexen-1-yne, 3-ethyl-3-buten-1-yne, and 3-phenyl-3-buten-1-yne;

alkenylsiloxane oligomers such as 1,3-divinyltetramethyldisiloxane, 1,3,5,7-tetravinyltetramethylcyclotetrasiloxane, and 1,3-divinyl-1,3-diphenyldimethyldisiloxane;

ethynyl-functional silicon compounds such as methyltris(3-methyl-1-butyn-3-oxy)silane;

nitrogenous compounds such as tributylamine, tetramethylethylenediamine, and benzotriazole;

phosphorus-containing compounds such as triphenylphosphine;

sulphur-containing compounds; and

hydroperoxy compounds;

maleic acid derivatives.

The acetylenic compounds as exemplified in (i) above are the most preferred cure inhibitors; these compounds generate a good balance between rapid curability of the composition and storage stability of the composition.

When used the cure inhibitor should be added in an amount of no more than 3 parts by weight per 100 parts by weight of component (A) and will generally be added in a range of from 0.001 to 3 parts by weight and preferably in a range of from 0.01 to 1 part by weight per 100 parts by weight of component (A).

The composition in accordance with the present invention comprises components (A), (B), (C), (D) and (E) as described above, and typically the resulting sponge made therefrom has sufficient physical strength due to the presence of component (B), however an additional a reinforcing microparticulate silica filler (F) in an amount of from 1 to 100 parts by weight per 100 parts by weight of component (A) may be used when required. Component (F) imparts an excellent mechanical strength to the electroconductive silicone rubber sponge afforded by thermal cure of the composition in accordance with the present invention and thereby acts to facilitate demolding of the resulting electroconductive silicone rubber. This reinforcing microparticulate silica filler may be exemplified by dry-method silicas such as fumed silica and by wet-method silicas such as precipitated silicas and by reinforcing microparticulate silica fillers which have been hydrophobically treated with an organosilicon compound such as an organochlorosilane, organoalkoxysilane, hexaorganodisilazane, dimethylhydroxysiloxy-endblocked diorganosiloxane oligomers, and/or cyclodiorganosiloxane oligomers. A single reinforcing microparticulate silica filler or a combination of reinforcing microparticulate silica fillers may be used.

Component (F) preferably has a BET specific surface area of at least 50 m²/g and more preferably of at least 100 m²/g. In use component (F) is added in a range of from 1 to 100 parts by weight per 100parts by weight of component (A) and preferably in a range of from 5 to 50 parts by weight per 100 parts by weight of component (A). If more than the maximum is used the blending of component (F) into component (A) becomes increasingly difficult and the viscosity of the composition in accordance with the present invention becomes so excessively high that handling characteristics of the composition are degraded.

When a hydrophobically treated silica filler is to be used as component (F), an untreated silica filler may be treated in situ by mixing component (A), untreated silica filler, and the surface treatment agent as referenced above.

Other optional components, that may be included in the composition of the present invention, are inorganic fillers such as calcined silica, aluminium hydroxide, aluminium oxide, quartz powder, diatomaceous earth, aluminosilicate, heavy calcium carbonate, light calcium carbonate, magnesium oxide, calcium silicate, and mica. These inorganic fillers may be used in an untreated condition or may be used after a preliminary treatment with a surface treatment agent. Further optional components include pigments such as iron oxide and titanium dioxide; heat stabilizers such as cerium oxide and cerium hydroxide; flame retardants such as manganese carbonate, zinc carbonate, and fumed titanium dioxide; particulate silicone additives such as silicone rubber powder and silicone resin powder; release agents such as stearic acid, calcium stearate, zinc stearate, and cerium stearate; and adhesion promoters.

The composition in accordance with the present invention may also contain a polydiorganosiloxane fluid lacking both Si-bonded alkenyl groups and Si-bonded hydrogen atoms. Examples of such fluids include trimethylsiloxy-endblocked polydimethylsiloxanes, dimethylhydroxysiloxy-endblocked polydimethylsiloxanes, trimethylsiloxy-endblocked dimethylsiloxane-methylphenylsiloxane copolymers, trimethylsiloxy-endblocked dimethylsiloxane-diphenylsiloxane copolymers, dimethylhydroxysiloxy-endblocked dimethylsiloxane-methylphenylsiloxane copolymers, and trimethylsiloxy-endblocked dimethylsiloxane-methyl(3,3,3-trifluoropropyl)siloxane copolymers.

In a second embodiment of the present invention there is provided an electroconductive silicone rubber sponge produced by the thermal curing of the electroconductive silicone rubber sponge composition hereinbefore described.

In a third embodiment of the present invention there is provided a method for preparing an electroconductive silicone rubber sponge composition comprising the following steps:

i) when component (F) is used, mixing the polyorganosiloxane (A) with reinforcing microparticulate silica filler (F) under the application of heat,

ii) preparing an electroconductive silicone rubber base by blending the electroconductive filler (B) into (A) or a mixture of (A) and (F), and

iii) blending hollow thermoplastic resin powder (C), liquid compound that has a boiling point above room temperature (D) and then curing agent (E) into the silicone rubber base.

Component (D) may be directly blended into the electroconductive silicone rubber base resulting from the mixing of component (A) with component (B). However, with a goal of improving the handling characteristics of component (D) and improving its dispersability in the electroconductive silicone rubber base, and insofar as the objects of this invention are not impaired, component (D) may first be converted into a mixture with a thickener (e.g., silica powder) or an adsorptive powder (e.g., a porous powder) and then blended in this form into the electroconductive silicone rubber base.

This invention additionally relates to a method for producing an electroconductive silicone rubber sponge, characterized by curing an electroconductive silicone rubber sponge composition in accordance with the invention. Curing is carried out by heating said composition to a temperature equal to or greater than the softening point of the thermoplastic resin of component (C).

The composition in accordance with the present invention may be readily prepared by combining components (A) to (E), or (A) to (F), and any optional components and mixing to homogeneity. When component (F) is used, however, it is preferable to first prepare a silicone rubber base by heating and kneading components (A) and (F) and any optional surface treatment agent for (F) and then admixing the other components with the silicone rubber base thus prepared. The apparatus for preparing the composition in accordance with the present invention may be, for example, a kneading apparatus or mixing apparatus such as a kneader mixer or continuous compounding extruder.

An electroconductive silicone rubber sponge may be prepared from the composition in accordance with the present invention by heating the composition to a temperature greater than or equal to the softening point of the thermoplastic resin constituting component (C). When this is done the composition in accordance with the present invention undergoes curing while foaming with the formation of an electroconductive silicone rubber sponge. Since the composition in accordance with the present invention can form good-quality silicone rubber sponge even in compression moulding using a mould and by extrusion moulding, it enables the moulding of electroconductive silicone rubber sponge in a variety of shapes, such as sheet, ring-shaped, strand, and tubular. A characteristic feature of the composition in accordance with the present invention is that it is very well suited for fabrication of composite mouldings with metal or another resin. The electroconductive silicone rubber sponge afforded by the cure of the composition in accordance with the present invention has uniform and microfine foam cells and is useful as gaskets for maintaining air tightness of building and construction elements and members; as flame-resistant gaskets, sealing materials, O-rings, and cushioning material; and as a surface-covering material for copier rolls.

### EXAMPLES

This invention is explained below through working and reference examples. In the examples that follow, “parts” denotes “parts by weight” and the values reported for viscosity were measured at 25° C.

### Reference Example 1

A 30 weight % solids solution of a silicone resin (softenig point=80° C., specific gravity=1.20) composed of methylsiloxane unit and methylphenylsiloxane unit in a 22:78 molar ratio in dichloromethane was initially prepared. 100 cm³/minute of the resin/dichloromethane solution and 25 cm³/minute of pure water were then delivered to a dynamic mixer and mixed to form an aqueous dispersion. The aqueous dispersion was continuously sprayed, using a dual-fluid nozzle, into a spray dryer operating with a nitrogen flow. The temperature of the nitrogen flow during this operation was 70° C. and the pressure was 0.05 MPa. The resulting hollow silicone resin powder was immersed for 24 hours in an aqueous solution comprising 100 parts of pure water and 1 part nonionic surfactant (ethylene oxide adduct on trimethylnonanol). The floating hollow silicone resin powder was separated and collected. The resulting hollow silicone resin powder had an average particle size of 40 μm and an average shell wall thickness of 4 μm and contained nitrogen gas in the interior.

### Reference Example 2

60 parts of ion-exchanged water was mixed to homogeneity in a flask with 40 parts of a water-soluble polyoxyalkylene-modified silicone oil (viscosity=400 mPa.s) having an average molecular formula

Me₃SiO-(Me₂SiO)₇-MeR⁴—SiO)₃—SiMe₃ (6)

wherein Me=methyl and R⁴=—(CH₂)₂—O—(C₂H₄O)₁₂—H) to give an aqueous solution G.

### Reference Example 3

50 parts of trimethylsiloxy-end blocked polydimethylsiloxane (viscosity=100 mPa.s) and 10 parts of polyoxyalkylene-modified silicone oil (viscosity=1,600 mPa.s) with the average molecular formula

Me₃SiO-(Me₂SiO)₇₀-(MeR⁴SiO)₃—SiMe₃ (7)

wherein Me and R⁴ are defined as above, were introduced into a flask and stirred vigorously. The gradual addition of 40 parts of ion-exchanged water with mixing resulted in the preparation of a water-in-oil emulsion in which the oil layer was trimethylsiloxy-endblocked polydimethylsiloxane (viscosity=100 mPa.s).

### Example 1

The following were introduced into a kneader mixer and kneaded to homogeneity with heating to form a silicone rubber base:

100 parts of dimethylvinylsiloxy-endblocked dimethylsiloxane-methylvinylsiloxane copolymer having a degree of polymerization of 3,000 and consisting of 99.85 mole % dimethylsiloxane units and 0.15 mole % methylvinylsiloxane units,

5 parts of dimethylhydroxysiloxy-endblocked dimethylsiloxane oligomer having a viscosity of 60 mPa.s, and

parts dry-method silica with a specific surface area of 200 m²/g.

15 parts of acetylene black (Denka Black from Denki Kagaku Kogyo Kabushiki Kaisha) was added to the 125 parts of the silicone rubber base and the mixture was kneaded to homogeneity at room temperature to give an electroconductive silicone rubber base.

To 100 parts of this electroconductive silicone rubber base were added:

part of trimethylsiloxy-endblocked dimethylsiloxane-methylhydrogensiloxane copolymer (viscosity=25 mPa.s, silicon-bonded hydrogen content=0.8 weight %),

0.015 parts of 1-ethynyl-1-cyclohexanol as hydrosilylation reaction inhibitor,

0.06 parts of chloroplatinic acid-tetramethyldivinyldisiloxane complex (platinum content=0.6 weight %),

part of the hollow silicone resin powder prepared in Reference Example 1, and 0.5 parts of distilled water.

The mixture was kneaded to homogeneity on a two-roll mill to form an electroconductive silicone rubber sponge composition. This composition was then converted into a 5 mm-thick sheet and introduced into a 250° C. oven and cured by heating for 10 minutes. An electroconductive silicone rubber sponge sheet was obtained. Examination of the foam cells in this electroconductive silicone rubber sponge sheet showed them to be substantially uniform and to have an average diameter of 0.1 to 0.4 mm.

### Example 2

The electroconductive silicone rubber sponge composition prepared in Example 1 was introduced into a single-screw extruder (diameter=65 mm) and was extruded as a tubular moulding. This tubular moulding was heated for 4 minutes in a 250° C. oven to provide a cured electroconductive silicone rubber sponge tube. The foam cells in this electroconductive silicone rubber sponge tube were substantially uniform and had a size of 0.1 to 0.5 mm.

### Example 3

16 cm³ of the electroconductive silicone rubber sponge composition prepared in Example 1 was introduced into a mould for compression moulding. The cavity defined by the mould was a right-angled parallel pipe with dimensions of 10 mm×40 mm×80 mm and a volume of 32 cm³. An electroconductive silicone rubber sponge moulding was obtained by heating for 15 minutes at 170° C. The outer shape of this electroconductive silicone rubber sponge moulding faithfully reproduced the shape of the mould cavity. The foam cells had diameters of 0.1 to 0.5 mm and were substantially uniform.

### Example 4

6 parts of Ketjenblack EC (Ketjen Black International Company) was added instead of the acetylene black to 125 parts of silicone rubber base prepared as in Example 1 and the mixture was kneaded to homogeneity at room temperature to give an electroconductive silicone rubber base. As in Example 1, to 100 parts of this electroconductive silicone rubber base were added:

part of trimethylsiloxy-endblocked dimethylsiloxane-methylhydrogensiloxane copolymer (viscosity=25 mPa.s, silicon-bonded hydrogen content=0.8 weight %),

0.015 parts of 1-ethynyl-1-cyclohexanol as hydrosilylation reaction inhibitor,

0.06 parts of chloroplatinic acid-tetramethyldivinyldisiloxane complex (platinum content=0.6 weight %),

part of the hollow silicone resin powder prepared in Reference Example 1, and 0.5 parts of distilled water.

The resulting mixture was kneaded to homogeneity on a two-roll mill to produce an electroconductive silicone rubber sponge composition. This composition was converted into a 5 mm-thick sheet moulding and then introduced into a 250° C. oven and was cured by heating for 10 minutes. An electroconductive silicone rubber sponge sheet was obtained. The foam cells in this electroconductive silicone rubber sponge sheet were uniform and had diameters of 0.1 to 0.5 mm.

### Example 5

The electroconductive silicone rubber sponge composition prepared in Example 4 was fed to a single-screw extruder (diameter=65 mm) and was extruded as a tubular moulding. This tubular moulding was heated for 5 minutes in a 230° C. oven to produce an electroconductive silicone rubber sponge tube. The foam cells in this electroconductive silicone rubber sponge tube were uniform and had diameters of 0.1 to 0.5 mm.

### Example 6

An electroconductive silicone rubber sponge composition was prepared as in Example 1, but in this case replacing the distilled water in Example 1 with 1.0 part (per 100 parts of the electroconductive silicone rubber base) of the aqueous solution G prepared in Reference Example 2. This composition was converted into a 5 mm-thick sheet and then introduced into a 250° C. oven and cured by heating for 10 minutes. An electroconductive silicone rubber sponge sheet was obtained. The foam cells in this electroconductive silicone rubber sponge sheet were uniform and had diameters of from 0.1 to 0.5 mm.

### Example 7

An electroconductive silicone rubber sponge composition was prepared as in Example 1, but in this case replacing the distilled water in Example 1 with 1.2 parts (per 100 parts of the electroconductive silicone rubber base) of the water-in-oil emulsion prepared in Reference Example 3. This composition was converted into a 5 mm-thick sheet and then introduced into a 250° C. oven and cured by heating for 10 minutes. An electroconductive silicone rubber sponge sheet was obtained. The foam cells in this electroconductive silicone rubber sponge sheet were uniform and had diameters of 0.1 to 0.5 mm.

### Comparative Example 1

An electroconductive silicone rubber sponge composition was prepared as in Example 1, but in this case without the addition of the hollow silicone resin powder that was added in Example 1. This composition was converted into a 5 mm-thick sheet and then introduced into a 250° C. oven and cured by heating for 10 minutes. An electroconductive silicone rubber sponge sheet was obtained. The foam cells in this electroconductive silicone rubber sponge sheet were on the whole large and non-uniform and a large number of foam cells with diameters of at least 3 mm were observed.

### Comparative Example 2

The electroconductive silicone rubber sponge composition prepared in Comparative Example 1 was fed to a single-screw extruder (diameter=65 mm) and was extruded as a tubular moulding. This tubular moulding was heated for 5 minutes in a 250° C. oven to give electroconductive silicone rubber sponge tube. The foam cells in this electroconductive silicone rubber sponge tube were large and non-uniform and a large number of foam cells with diameters of at least 3 mm were observed.

### Comparative Example 3

16 cm³ of the electroconductive silicone rubber sponge composition prepared in Comparative Example 1 was introduced into a mould for compression moulding. The cavity defined by this mould was a right-angled parallel pipe with dimensions of 10 mm×40 mm×80 mm and had a volume of 32 cm³. An electroconductive silicone rubber sponge moulding was obtained by heating for 15 minutes at 170° C. While the outer shape of this electroconductive silicone rubber sponge moulding faithfully reproduced the shape of the cavity, the foam cells were non-uniform and a large number of foam cells with diameters of at least 3 mm were observed.

### Comparative Example 4

An electroconductive silicone rubber sponge composition was prepared as in Example 4, but in this case without adding the hollow silicone resin powder that was added in Example 4. This composition was converted into a 5 mm-thick sheet and then introduced into a 250° C. oven and cured by heating for 10 minutes. An electroconductive silicone rubber sponge sheet was obtained. The foam cells in this electroconductive silicone rubber sponge sheet were on the whole large and non-uniform and a large number of foam cells with diameters of at least 3 mm were observed.

1. An electroconductive silicone rubber sponge composition comprising:
100 parts by weight of a polyorganosiloxane having a weight average degree of polymerisation of at least 1000,
1 to 100 parts by weight of an electroconductive filler,
0.01 to 50 parts by weight of a hollow thermoplastic resin powder,
0.1 to 10 parts by weight of a liquid compound that has a boiling point above room temperature, and
a curing agent in an amount sufficient to cure the composition.

2. A composition in accordance with claim 1 wherein said composition additionally contains component (F), 1 to 100 parts by weight of a reinforcing microparticulate silica filler for each 100 parts by weight of component (A).

3. A composition in accordance with any preceding claim characterized in that component (B) is carbon black.

4. A composition in accordance with any preceding claim characterised in that component (C) comprises a thermoplastic resin shell with a softening point of from 40° C. to 200° C. and contains a gas in its interior.

5. A composition in accordance with any preceding claim characterised in that the thermoplastic resin powder is silicone resin, acrylic resin, or polycarbonate resin.

6. A composition in accordance with any preceding claim characterised in that component (D) is water.

7. A composition in accordance with any preceding claim characterised in that component (A) is a polyorganosiloxane containing at least two silicon-bonded alkenyl groups and component (E) comprises:
a platinum-based catalyst, wherein the amount of platinum metal in said platinum-based catalyst is from 0.01 to 500 parts by weight per 1,000,000 parts by weight of component (A); and
a polyorganosiloxane containing at least two silicon-bonded hydrogen atoms per molecule, in an amount such that the ratio of the number of moles of silicon-bonded hydrogen to the number of moles of silicon-bonded alkenyl in component (A) is from 0.5:1 to 20:1.

8. A composition in accordance with any preceding claim wherein component (A) has a weight average degree of polymerisation of at least about 3000.

9. Use of a composition in accordance with any preceding claim in extrusion moulding and/or compression moulding using a mould.

10. A method for preparing an electroconductive silicone rubber sponge composition in accordance with claim 2, said method being characterized by the following steps
mixing the polyorganosiloxane (A) with reinforcing microparticulate silica filler (F) under the application of heat,
preparing an electroconductive silicone rubber base by blending the electroconductive filler (B) into the mixture of (A) and (F), and
blending the hollow thermoplastic resin powder (C), the liquid compound that has a boiling point above room temperature (I) and then the curing agent (E) into the silicone rubber base.

11. An Electroconductive silicone rubber sponge made from the composition in accordance with any one of claims 1 to 8.

12. A method of producing an electroconductive silicone rubber sponge in accordance with claim 11 comprising the sequential steps:
when component (F) is used, mixing the polyorganosiloxane (A) with the reinforcing microparticulate silica filler (F) under the application of heat, preparing an electroconductive silicone rubber base by blending the electroconductive filler (B) into (A) or a mixture of (A) and (F),
blending the hollow thermoplastic resin powder (C), the liquid compound that has a boiling point above room temperature (D) and then the curing agent (E) into the silicone rubber base, and
thermally curing the composition produced in step (iii).

13. A method in accordance with claim characterized in that thermal curing is undertaken at a temperature equal to or greater than the softening point of the thermoplastic resin of component (C).
